(19) United States
(12) Patent Application Publication
(10) Pub. No.: US 2025/0083345 A1
(43) Pub. Date: Mar. 13, 2025

(54) ADJUSTABLE CUTTER

(71) Applicant: HONG JIN HARDWARE CORPORATION, TAICHUNG (TW)

(72) Inventor: Chung Tsai, TAICHUNG (TW)

(21) Appl. No.: 18/367,463

(22) Filed: Sep. 13, 2023

(51) Int. Cl. B26B 17/00

(52) U.S. Cl. CPC B26B 17/00; H02G 3/0456

(57) ABSTRACT

An adjustable cutter is devised to cut a wire trough. The adjustable cutter includes a handle, a cutting board, a blade, a connecting unit and a lever. The cutting board is connected to the handle. The connecting unit is connected to the blade. The connecting unit is pivotally connected to the handle so that the blade is pivotable relative to the cutting board. The lever is pivotally connected to the handle and used with the connecting unit to render the lever between a closed on and an open position relative to the handle. A screw hole is made in the handle. A screw includes a first end located in the screw hole and a second end in contact with the lever. The screw does not interfere with the movement of the lever toward the handle. The screw controls how far the lever is pivotable from the handle.

### BACKGROUND OF INVENTION

### 1. Field of Invention

The present invention relates to a cutter and, more particularly, to an adjustable cutter.

### 2. Related Prior Art

A wire trough is used in an aisle to receive one wire or more to prevent a person from treading one the wire(s) or tumbling over the wire(s). A wire trough is often made of a plastic material such as disclosed in Chinese Patent No. 305169727.

A knife or saw can be used to cut a wire trough to a desired length. The wire trough is attached to a floor or wall with adhesive for example. A cutter that includes a blade and a cutting board can be used to cut the wire trough. However, the blade of the cutter tends to slide on a convex face of the wire trough, thereby rendering it difficult to cut the wire trough with the cutter.

To solve the foregoing problem, the inventor of the present invention has devised a cutter to which Taiwanese Patent No. M633764 has been issued.

The present invention is therefore intended to obviate or at least alleviate the problems encountered in the prior art.

### SUMMARY OF INVENTION

It is the primary objective of the present invention to provide an effective and efficient cutter.

To achieve the foregoing objective, the adjustable cutter includes a handle, a cutting board, a blade, a connecting unit and a lever. The cutting board is connected to the handle. The connecting unit is connected to the blade. The connecting unit is pivotally connected to the handle so that the blade is pivotable relative to the cutting board. The lever is pivotally connected to the handle and used with the connecting unit to render the lever between a closed on and an open position relative to the handle. A screw hole is made in the handle. A screw includes a first end located in the screw hole and a second end in contact with the lever. The screw does not interfere with the movement of the lever toward the handle. The screw controls how far the lever is pivotable from the handle.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a side view of an adjustable cutter according to the first embodiment of the present invention;

FIG. 2 is an enlarged partial front view of the adjustable cutter shown in FIG. 1;

FIG. 3 is a side view of the adjustable cutter in another position than shown in FIG. 1;

FIG. 4 is a side view of the adjustable cutter in another mode than shown in FIG. 3; and

FIG. 5 is a side view of an adjustable cutter according to the second embodiment of the present invention.

### DETAILED DESCRIPTION OF PREFERRED EMBODIMENT

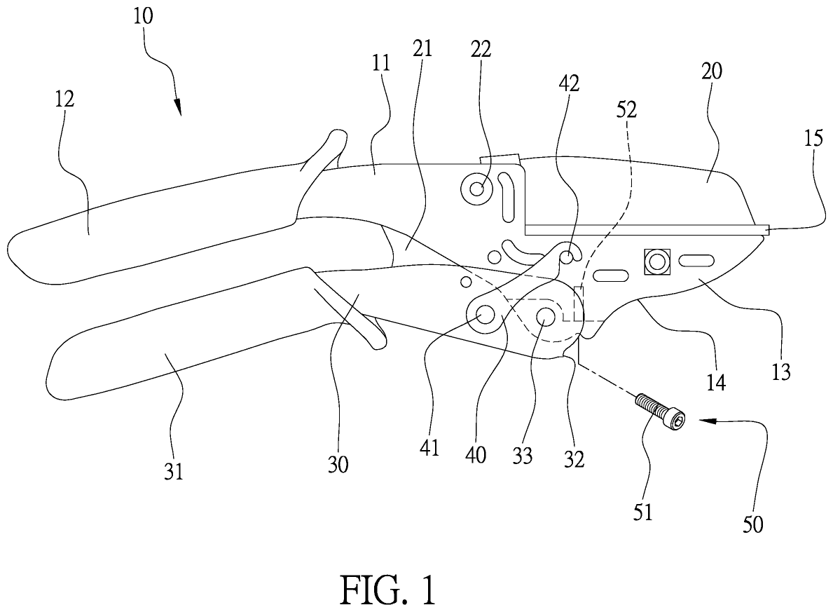

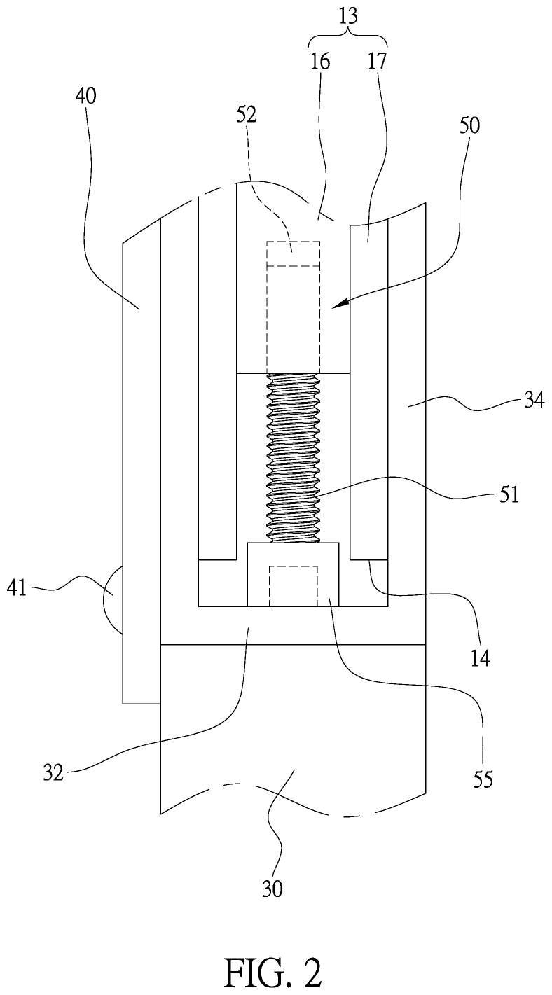

Referring to FIGS. 1 and 2, a cutter 10 includes a handle 11, a cutting board 15, a blade 20, a connecting unit 21, a lever 30, a hook 40 and an adjusting unit 50 according to the preferred embodiment of the present invention.

The handle 11 is preferably made of metal and includes a rear end inserted in a grip 12 preferably made of a non-metallic material such as a plastic material by injection molding or by a combination of insertion with adhesion for example. A jaw 13 is formed at the front end of the handle 11 that extends from the grip 12. The jaw 13 preferably includes a flat upper edge (not numbered) and a curved lower edge 14. The cutting board 15 is located at the flat upper edge of the jaw 13. The cutting board 15 is connected to the jaw 13 with a rivet or a combination of a screw with a nut for example. The upper edge of the jaw 13 is located lower than an upper edge of the remaining portion of the handle 11. The jaw 13 (or the entire handle 11) preferably includes an intermediate plate 16 sandwiched between two lateral plates 17 so that the jaw 13 is made with adequate width or breadth for properly supporting the cutting board 15.

The blade 20 is connected to the connecting unit 21. A pivot unit 22 is used to connect the connecting unit 21 to a middle portion of the handle 11 to keep the blade 20 extending from the handle 11 above the cutting board 15. The blade 20 is movable relative to the cutting board 15 about the pivot unit 22.

The lever 30 is preferably made of metal and includes a rear end inserted in a grip 31 that is made of a non-metallic material such as a plastic material. The lever 30 includes a front end connected to a lower portion of the jaw 13 with a pivot 33, thereby rendering the lever 30 pivotable relative to the handle 11 between an open position and a closed position about the pivot 33. The lever 30 is connected to the connecting unit 21 so that the blade 20 is pivotable relative to the jaw 13 between an open position and a closed position as the lever 30 is pivotable relative to the handle 11 between the open and closed positions. The connection of the lever 30 to the connecting unit 21 will be described in detail later.

The lever 30 preferably includes two fins 34 extending from a bottom (not numbered). A front end of the bottom of the lever 30 is formed with an abutting portion 32. The fins 34 are located on two opposite sides of the jaw 13, i.e., the lateral plates 17 are located between the fins 34. The fins 34 are connected to the lateral plates 17 with the pivot 33.

The hook 40 includes a rear end pivotally connected to the lever 30 with a pivot 41. The hook 40 includes a front end operable to hook a rod 42 extending from a side of the jaw 13 to keep the lever 30 in the closed position relative to the handle 11. Now, the connecting unit 21 biases the blade 20 toward the cutting board 15.

The adjusting unit 50 includes a screw 51 inserted in a screw hole 52 preferably made in the lower portion of the jaw 13 of the handle 11. In specific, the screw hole 52 is made in a lower portion of the intermediate plate 16. The screw 51 preferably includes a head 55 located out of the screw hole 52. The screw 51 is rotatable in the screw hole 52 relative to the lower portion of the jaw 13 to adjust a distance of the head 55 from the lower portion of the jaw 13. The head 55 of the screw 51 is in contact with the abutting portion 32 of the jaw 13.

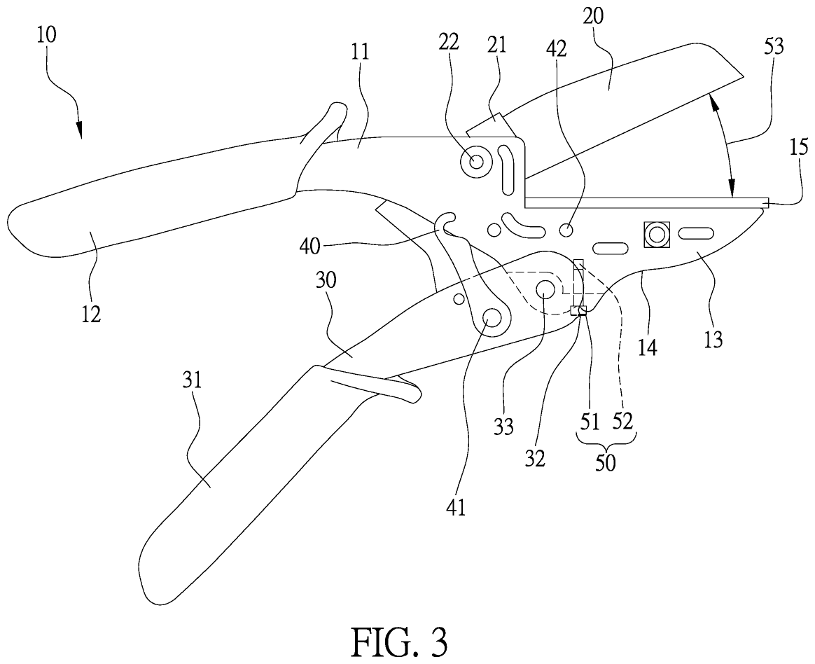

Referring to FIGS. 2 and 3, the hook 40 is disengaged from the rod 42 to allow the lever 30 to be pivoted from the handle 11. The connecting unit 21 is loaded with elastic or mechanical energy to pivot the lever 30 to the open position from the closed position relative to the handle 11. Accordingly, the blade 20 is in the open position relative to the cutting board 15, with an angle between them.

Now, the head 55 of the screw 51 is at a short distance from the lower portion of the jaw 13. Thus, the blade 20 can be at a large angle 53 from the cutting board 15 to allow the cutter 10 to cut a thick wire trough (not shown).

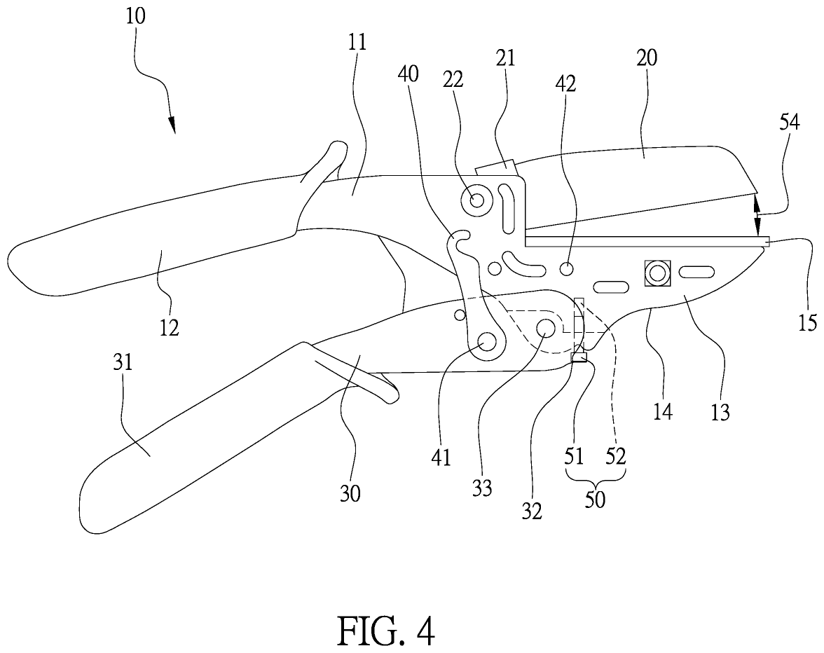

Referring to FIGS. 2 and 4, the head 55 of the screw 51 is at a long distance from the lower portion of the jaw 13. Thus, the blade 20 can be at a small angle 54 from the cutting board 15 to allow the cutter 10 to cut a thin wire trough (not shown) only.

The screw 51 does interfere with the pivoting of the lever 30 toward the handle 11 or the pivoting of the blade 20 toward the cutting board 15. The screw 51 however controls how far the lever 30 can be pivoted from the handle 11 and how far the blade 20 can be pivoted from the cutting board 15.

As discussed above, the adjusting unit 50 is used to control how far the lever 30 is pivotable from the handle 11, thereby controlling how thick a wire trough (not numbered) can be cut with the cutter 10.

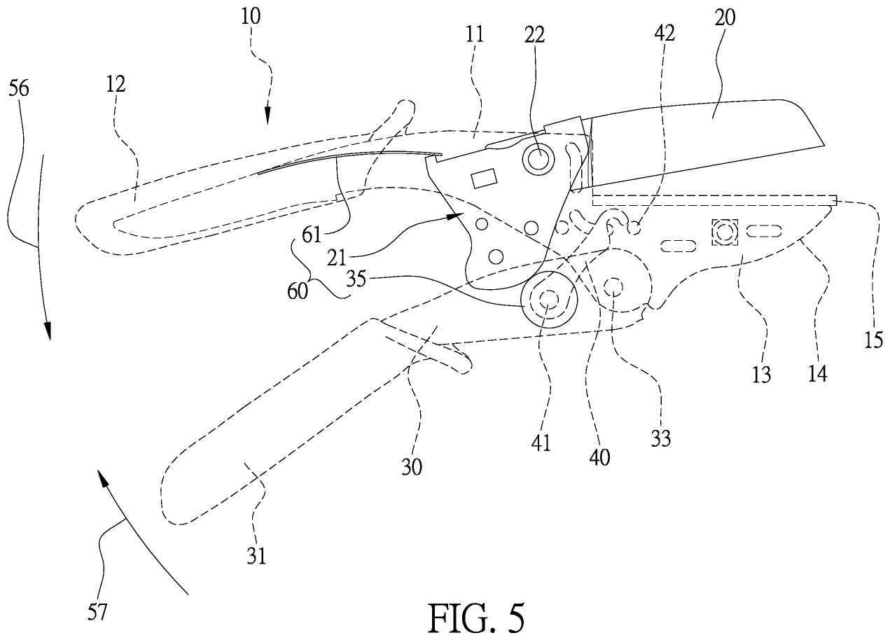

Referring to FIG. 5, according to a second embodiment of the present invention, the cutter 10 includes a force saver 60 in addition to the first embodiment of the present invention. The force saver 60 includes a roller 35 and a leaf spring 61 in addition to the connecting unit 21. The roller 35 is located in the lever 30, i.e., between the fins 34. A pivot 41 is used to connect the roller 35 to the fins 34 so that the roller 35 is rotatable about the pivot 41. The leaf spring 61 is an arched one including a rear end located in and connected to the handle 11 and a front end extending toward the lever 30. Thus, the leaf spring 61 tends to rotate the connecting unit 21 about the pivot unit 22 and roll a periphery of the connecting unit 21 on a periphery of the roller 35. Thus, the leaf spring 61 tends to pivot the lever 30 from the handle 11.

Two forces 56 and 57 are respectively exerted on the grips 12 and 31 to bring the lever 30 to the closed position relative to the handle 11. The roller 35 pushes the connecting unit 21 which in turn pushes the front end of the leaf spring 61, thereby unbending the leaf spring 61. As the connecting unit 21 is connected to the blade 20, the blade 20 is pivoted toward the cutting board 15 to cut a wire trough (not shown) that is located between the blade 20 and the cutting board 15.

In another embodiment of the present invention, the force saver 60 can include another element instead of the leaf spring 61 for opening the cutter 10.

The present invention has been described via the illustration of the embodiments. Those skilled in the art can derive variations from the embodiments without departing from the scope of the present invention. Therefore, the embodiments shall not limit the scope of the present invention defined in the claims.

1. An adjustable cutter comprising:
a handle;
a cutting board connected to the handle;
a blade;
a connecting unit connected to the blade, wherein the connecting unit is pivotally connected to the handle so that the blade is pivotable relative to the cutting board;
a lever pivotally connected to the handle and used with the connecting unit to render the lever between a closed on and an open position relative to the handle;
a screw hole in the handle; and
a screw comprising a first end located in the screw hole and a second end in contact with the lever;
wherein the screw does not interfere with the movement of the lever toward the handle;
wherein the screw controls how far the lever is pivotable from the handle.

2. The adjustable cutter according to claim 1, wherein the handle comprises two lateral plates and an intermediate plate sandwiched between two lateral plates.

3. The adjustable cutter according to claim 2, wherein the screw hole is made in the intermediate plate.

4. The adjustable cutter according to claim 1, wherein the lever comprises two fins on two opposite sides of the handle.

5. The adjustable cutter according to claim 4, wherein the lever comprises an abutting portion between the fins, wherein the abutting portion is in contact with the second end of the screw.

6. The adjustable cutter according to claim 2, wherein the lever comprises two fins, wherein the lateral plates are located between the fins.

7. The adjustable cutter according to claim 1, wherein the screw comprises a head at the second end, where the head is further from an edge of the handle as the less the lever is pivotable from the handle.
